(19) United States
(12) Patent Application Publication
(10) Pub. No.: US 2014/0055314 A1
(43) Pub. Date: Feb. 27, 2014

(54) DOUBLY SHAPED REFLECTOR TRANSMITTING ANTENNA FOR MILLIMETER-WAVE SECURITY SCANNING SYSTEM

(71) Applicant: Northeastern University, Boston, MA (US)

(72) Inventor: Carey Rappaport, Wellesley, MA (US)

(73) Assignee: Northeastern University, Boston, MA (US)

(21) Appl. No.: 13/971,430

(22) Filed: Aug. 20, 2013

Related U.S. Application Data
(60) Provisional application No. 61/691,487, filed on Aug. 21, 2012.

(51) Int. Cl. H01Q 15/16

(52) U.S. Cl. CPC H01Q 15/16
USPC 343/840

(57) ABSTRACT

In some aspects, the disclosure is directed methods and systems for focusing millimeter-wave radiation to a line for scanning a target object. A source may provide millimeter-wave radiation, and may include a substantially point source. A reflector may include a surface with an elliptical cross-section within a first plane and a curved cross-section within a second plane perpendicular to the first plane. The curved cross-section may be shaped differently from the elliptical cross-section within their respective planes. The surface may focus the millimeter-wave radiation from the source at a line on a third plane parallel to or coinciding with the second plane. The line may be located at an approximate location where a target object is expected to be positioned. At least one sensor may measure the millimeter-wave radiation from the reflector scattered off the target object.

### RELATED APPLICATION

This application claims priority to U.S. Provisional Patent Application No. 61/691,487, entitled “Doubly Shaped Reflector Transmitting Antenna for Millimeter-Wave Security Scanning System”, filed Aug. 21, 2012, which is incorporated herein by reference in its entirety for all purposes.

### FIELD OF THE DISCLOSURE

This disclosure generally relates to systems and methods for detection of concealed or unknown objects and materials. In particular, this disclosure relates to systems and methods for using a doubly shaped reflector transmitting antenna for millimeter-wave security scanning

### BACKGROUND OF THE DISCLOSURE

In conventional systems utilizing near-field millimeter wave imaging for surveillance and detection purposes, an object of interest may be illuminated and the scattered field measured and processed to reconstruct the surface or volume of the object. For three dimensional reconstruction, multiple illuminating and receiving views may be required, and the computational burden can be significant. The number of required sensor elements in a two or three dimensional array may be too cost-prohibitive in a system. To perform a near-360-degree reconstruction, one conventional approach is to provide a long, vertical, uniform source, somewhat like a fluorescent tube, to provide illumination along a height of a subject. Such a source may be moved along an arc around the subject to scan the subject from different sides. This not only requires a long uniform source, but also demands mechanical means to move the source and detector(s) along the arc.

### BRIEF SUMMARY OF THE DISCLOSURE

Described herein are systems and methods for using a doubly shaped reflector transmitting antenna for millimeter-wave security scanning Embodiments of the present systems and methods may use a doubly-shaped reflector to generate a narrow illuminating slice within a predetermined range for millimeter-wave imaging. The beam produced by this reflector may be focused to a narrow region in the vertical plane. The rays may be configured to be collimated, converging or diverging in the horizontal plane. Such focused beams can allow for interrogation and reconstruction of a narrow portion of the target object. The reflector and a corresponding receiving antenna array may be translated vertically and/or rotated relative to the target object. Narrow reconstructions obtained from measurements by the receiver antenna array may be stacked to form a full or partial surface body reconstruction.

In some aspects, the present disclosure pertains to a system for focusing millimeter-wave radiation to a line for scanning a target object. The system may include a source that provides millimeter-wave radiation. The source may include a substantially point source. A reflector may include a surface with an elliptical cross-section within a first plane and a curved cross-section within a second plane perpendicular to the first plane. The curved cross-section may be shaped differently from the elliptical cross-section within their respective planes. The surface may focus the millimeter-wave radiation from the source at a line on a third plane parallel to or coinciding with the second plane. The line may be located at an approximate location where a target object is expected to be positioned. At least one sensor may measure the millimeter-wave radiation from the reflector scattered off the target object.

In some embodiments, the surface comprises a parabolic cross-section along the second plane. The surface may focus the millimeter-wave radiation at the line, the line comprising a straight line on the third plane. In certain embodiments, the surface comprises a hyperbolic cross-section along the second plane. The surface may focus the millimeter-wave radiation at the line, the line comprising a circular arc on the third plane. The surface may focus the millimeter-wave radiation at the line, the line comprising a curved line on the third plane. The surface may provide constant path length sum for millimeter-wave radiation from the source to any point on the reflector, and from that point to the line of focus in a perpendicular manner. The surface may focus the millimeter-wave radiation at the line to provide an extended scanning range on the third plane. The extended scanning range may comprise distances proximate to the location of the line at which the target object may be scanned with the focused millimeter-wave radiation. The surface may focus the millimeter-wave radiation to comprise collimated rays within the second plane.

In certain embodiments, at least one of: the source, the reflector and the at least one sensor, is moved in a direction substantially perpendicular to the third plane, relative to the target object. The at least one sensor may measure millimeter-wave radiation scattered from the target object at predetermined points along the direction of movement. The system may include at least one other reflector surface to focus millimeter-wave radiation from a different direction relative to the target object.

In some aspects, the present disclosure pertains to method for focusing millimeter-wave radiation to a line for scanning a target object. The method may include providing, by a substantially point source, millimeter-wave radiation. A surface of a reflector may focus the millimeter-wave radiation from the source at a line located at an approximate location where a target object is expected to be positioned. The surface may include an elliptical cross-section within a first plane and a curved cross-section within a second plane perpendicular to the first plane. The curved cross-section may be shaped differently from the elliptical cross-section within their respective planes. The line may be on a third plane parallel to or coinciding with the second plane. At least one sensor may measure the millimeter-wave radiation from the reflector scattered off the target object.

In some embodiments, the surface focuses the millimeter-wave radiation at the line, the surface comprising a parabolic cross-section along the second plane. The surface may focus the millimeter-wave radiation at the line, the line comprising a straight line on the third plane. In some embodiments, the surface focuses the millimeter-wave radiation at the line. The surface may include a hyperbolic cross-section along the second plane. The surface may focus the millimeter-wave radiation at the line, the line comprising a circular arc with center behind the reflector on the third plane. The surface may include a elliptical cross-section along the second plane. The surface may focus the millimeter-wave radiation at the line, the line comprising a circular arc with center in front of the reflector on the third plane. The surface may focus the millimeter-wave radiation at the line, the line comprising a curved line on the third plane. The surface may focus the millimeter-wave radiation at the line, the surface providing constant path length sum for millimeter-wave radiation from the source to any point on the reflector, and from that point to the line of focus in a perpendicular manner. The surface may focus the millimeter-wave radiation at the line to provide an extended scanning range on the third plane. The extended scanning range may include distances proximate to the location of the line at which the target object may be scanned with the focused millimeter-wave radiation. The surface may focus the millimeter-wave radiation to comprise collimated rays within the second plane.

In some embodiments, a mechanical subsystem may move at least one of: the source, the reflector and the at least one sensor, in a direction substantially perpendicular to the third plane, relative to the target object. At least one sensor may measure the millimeter-wave radiation from the reflector scattered off the target object. The measurement may be performed at predetermined points along the direction of movement. At least one other reflector surface may be provided to focus millimeter-wave radiation from a different direction relative to the target object.

The details of various embodiments of the invention are set forth in the accompanying drawings and the description below.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 2A is a block diagram depicting one embodiment of a system for focusing millimeter-wave radiation to a line for scanning a target object;

FIGS. 2B and 2C show embodiments of a configuration of the reflector producing a blade beam to illuminate a subject;

FIGS. 2D and 2E show embodiments of rays from a system focus transmitted to a surface of a reflector, and reflected to the focal line;

FIG. 2F shows one embodiment of a generalized ellipse;

FIGS. 2G and 2H show schematic views of one embodiment of a reflector and a resulting beam as a collection of rays from the reflector to a target object;

FIGS. 2I, 2J and 2K show embodiments of radiation characteristics provided by a system for focusing millimeter-wave radiation to a line for scanning a target object;

FIGS. 2L, 2M and 2N show other embodiments of radiation characteristics provided by a system using a variant shape of the reflector;

FIGS. 2O, 2P and 2Q show yet other embodiments of radiation characteristics provided by a system for focusing millimeter-wave radiation to a line for scanning a target object;

FIGS. 2R, 2S and 2T show three cuts through a secondary focal region to illustrate radiation characteristics provided by one embodiment of a system for focusing millimeter-wave radiation to a line for scanning a target object;

FIG. 2U shows another embodiment of a system for focusing millimeter-wave radiation to a line for scanning a target object;

FIG. 2V shows one embodiment of an expected scattered field arising from a system focusing millimeter-wave radiation at the target object;

FIG. 2W shows one embodiment of an image constructed or derived from scattered field arising from a system focusing millimeter-wave radiation at the target object; and

FIG. 2X shows one embodiment of a method for focusing millimeter-wave radiation to a line for scanning a target object.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods using a doubly shaped reflector transmitting antenna for millimeter-wave security scanning

### A. Computing and Network Environment

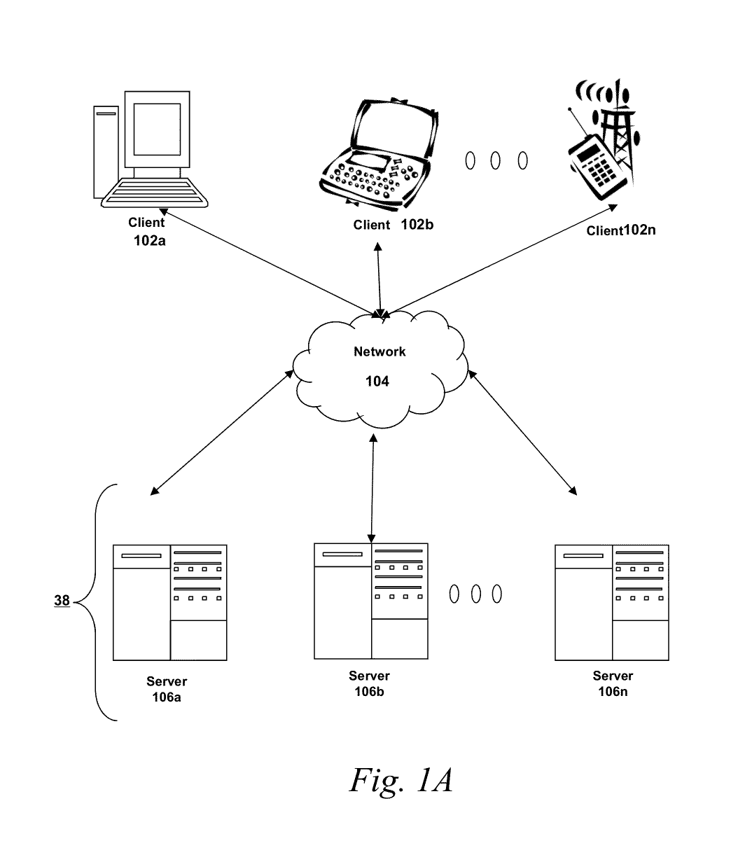

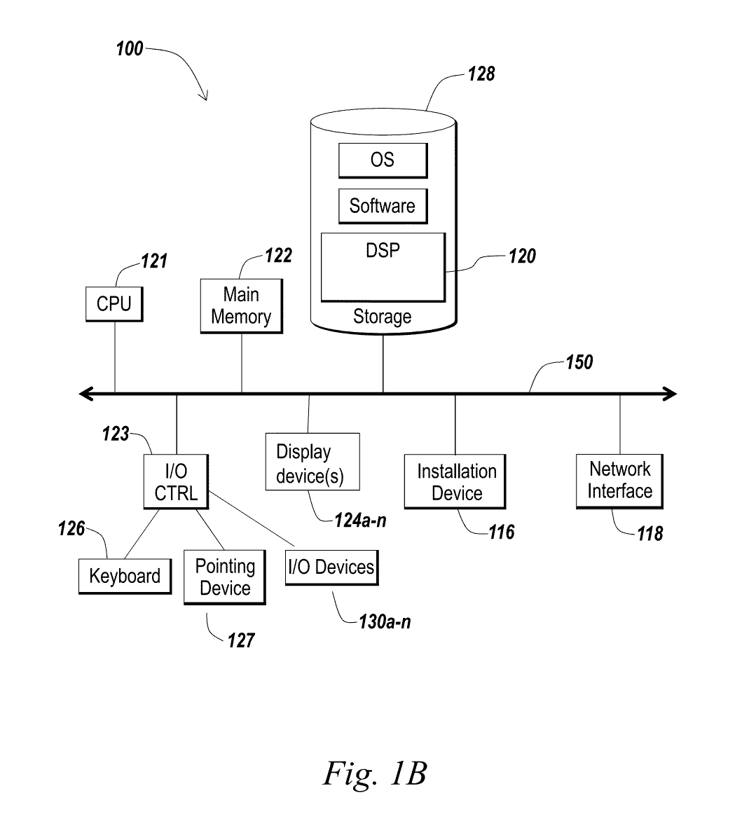

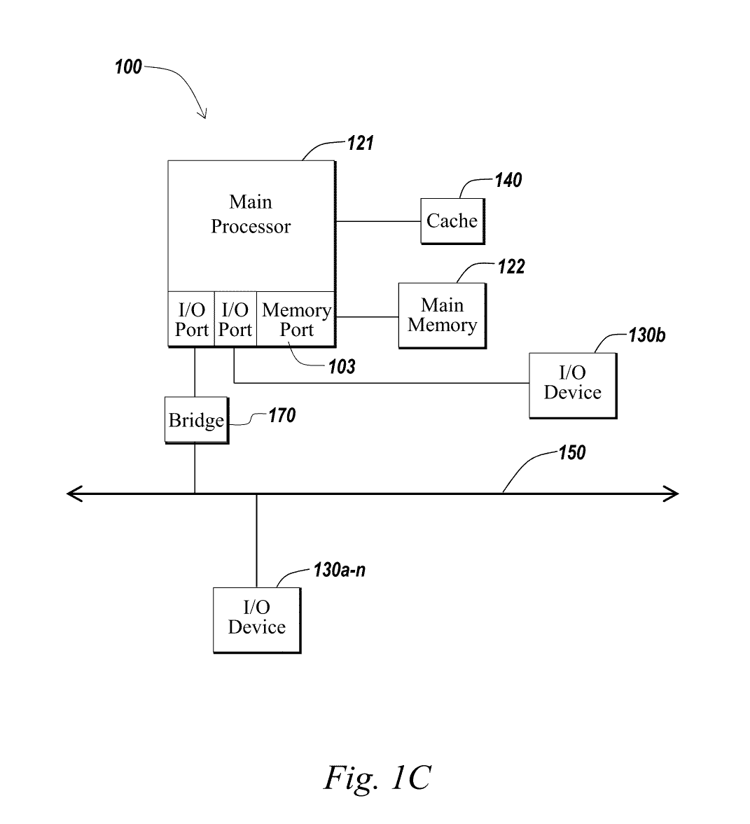

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 101a-101n (also generally referred to as local machine(s) 101, client(s) 101, client node(s) 101, client machine(s) 101, client computer(s) 101, client device(s) 101, endpoint(s) 101, or endpoint node(s) 101) in communication with one or more servers 106a-106n (also generally referred to as server(s) 106, node 106, or remote machine(s) 106) via one or more networks 104. In some embodiments, a client 101 has the capacity to function as both a client node seeking access to resources provided by a server and as a server providing access to hosted resources for other clients 101a-101n.

Although FIG. 1A shows a network 104 between the clients 101 and the servers 106, the clients 101 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 101 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol(s) or standard(s) used to communicate among mobile devices, including AMPS, TDMA, CDMA, GSM, GPRS, UMTS, WiMAX, 3G or 4G. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the Virtual Server or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 101 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In one embodiment, the server 106 provides the functionality of a web server. In another embodiment, the server 106a receives requests from the client 101, forwards the requests to a second server 206b and responds to the request by the client 101 with a response to the request from the server 106b. In still another embodiment, the server 106 acquires an enumeration of applications available to the client 101 and address information associated with a server 106′ hosting an application identified by the enumeration of applications. In yet another embodiment, the server 106 presents the response to the request to the client 101 using a web interface. In one embodiment, the client 101 communicates directly with the server 106 to access the identified application. In another embodiment, the client 101 receives output data, such as display data, generated by an execution of the identified application on the server 106.

The client 101 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 101 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-101n, a keyboard 126 and a pointing device 127, such as a mouse. The storage device 128 may include, without limitation, an operating system and/or software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), NAND Flash, NOR Flash and Solid State Drives (SSD). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 may communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, touch pads, and drawing tablets. Output devices include video displays, speakers, inkjet printers, laser printers, projectors and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a disk drive, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for the demand side platform. Optionally, any of the installation devices 116 could also be used as the storage device. Additionally, the operating system and the software can be run from a bootable medium, for example, a bootable CD.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, manufactured by Google Inc; WINDOWS 7 and 8, manufactured by Microsoft Corporation of Redmond, Wash.; MAC OS, manufactured by Apple Computer of Cupertino, Calif.; WebOS, manufactured by Research In Motion (RIM); OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPAD or IPOD family of devices manufactured by Apple Computer of Cupertino, Calif., a device of the PLAYSTATION family of devices manufactured by the Sony Corporation of Tokyo, Japan, a device of the NINTENDO/Wii family of devices manufactured by Nintendo Co., Ltd., of Kyoto, Japan, or an XBOX device manufactured by the Microsoft Corporation of Redmond, Wash.

In some embodiments, the computing device 100 may have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry handheld or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a tablet such as the Apple IPAD, or a digital audio player such as the Apple IPOD lines of devices, manufactured by Apple Computer of Cupertino, Calif. In another of these embodiments, the digital audio player may function as both a portable media player and as a mass storage device. In other embodiments, the computing device 100 is a digital audio player such as an MP3 players. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the communications device 101 includes a combination of devices, such as a mobile phone combined with a digital audio player or portable media player. In one of these embodiments, the communications device 101 is a smartphone, for example, an iPhone manufactured by Apple Computer, or a Blackberry device, manufactured by Research In Motion Limited. In yet another embodiment, the communications device 101 is a laptop or desktop computer equipped with a web browser and a microphone and speaker system, such as a telephony headset. In these embodiments, the communications devices 101 are web-enabled and can receive and initiate phone calls.

In some embodiments, the status of one or more machines 101, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Using a Doubly Shaped Reflector Transmitting Antenna for Millimeter-Wave Security Scanning

Described herein are systems and methods for using a doubly shaped reflector transmitting antenna for millimeter-wave, microwave or sub-millimeter wave security scanning The present disclose may sometimes reference a millimeter-wave implementation for purposes of illustration, and should be construed to be limiting in any way. In some embodiments, the present systems and methods include the use of a reflector antenna for near-field millimeter-wave imaging applications. By combining parabolic curvature in one plane with elliptical curvature in the other for example, this antenna can generate a “blade beam,” focusing radiated field at a straight or curved line. When excited at the reflector's elliptical profile's first focal point, transmitted rays may be collimated, spread out or converged in the first (horizontal) plane, each passing through the focal line at the second ellipse focus. As such, the rays can illuminate a narrow slice of a subject or object to be imaged. With the illumination focused on this slice, the scattered field due to this narrow portion or contour of the object may be measured. This may allow for computationally simple inversion of a one-dimensional contour rather than an entire two-dimensional surface. Stacking the reconstructed contours for various horizontal positions can provide the full object image.

At present, radar may be the only modality that can penetrate and sense beneath clothing at a distance (e.g., 10 to 50 meters) without causing physical harm to a subject. In active near-field millimeter wave imaging for example, an object of interest may be first illuminated and then a corresponding scattered field may be measured and processed to reconstruct the surface (or volume) of the object. For three dimensional reconstruction, multiple illuminating and receiving views may be required, and the corresponding computational burden can be significant. One approach to limit the number of sensor elements may be to synthesize a virtual aperture by moving radar antenna elements around the object. Such a near-field synthetic aperture radar (SAR) technique may trade the advantage of reducing hardware with extending observation time. While the computational load for SAR may still be significant, this can be reduced by considering monostatic observations, in which each antenna element is used for transmitting and receiving a given signal. Monostatic SAR may require fast switching between radiating elements, and may be affected by reconstructing artifacts such as dihedral effects and misrepresenting sudden indentations and protrusions.

According to the present systems and methods, one means of reducing sensing hardware while making use of moving antennas may be to restrict the illuminated portion of the target object. An approach may comprise reconstructing just this illuminated portion, translating the illuminating spot and stacking the successive reconstructions. As long as there is no significant scattering interaction between the adjacent illuminated object portions, this portion-by-portion stacking can produce a reasonable reconstruction of the 3D surface.

In certain embodiments, the present systems and methods may be incorporated into near-field scanning and imaging systems, for example in portal-based security systems at airports and building entrances. An electromagnetic system, such as a radar system, may be used to measure an electromagnetic response of radiation incident on a subject to perform scanning or probing. The system may recover or detect a geometrical profile or characteristic from the response. For example, the system may detect an electromagnetic excitation from a subject wearing an object under clothing. The electromagnetic excitation may cause or result in scattered or reflected field that the system may detect, collect, record and/or measure. The system may process data on the reflections or scattered field using one or more algorithms to detect and/or identify an object on the subject's body.

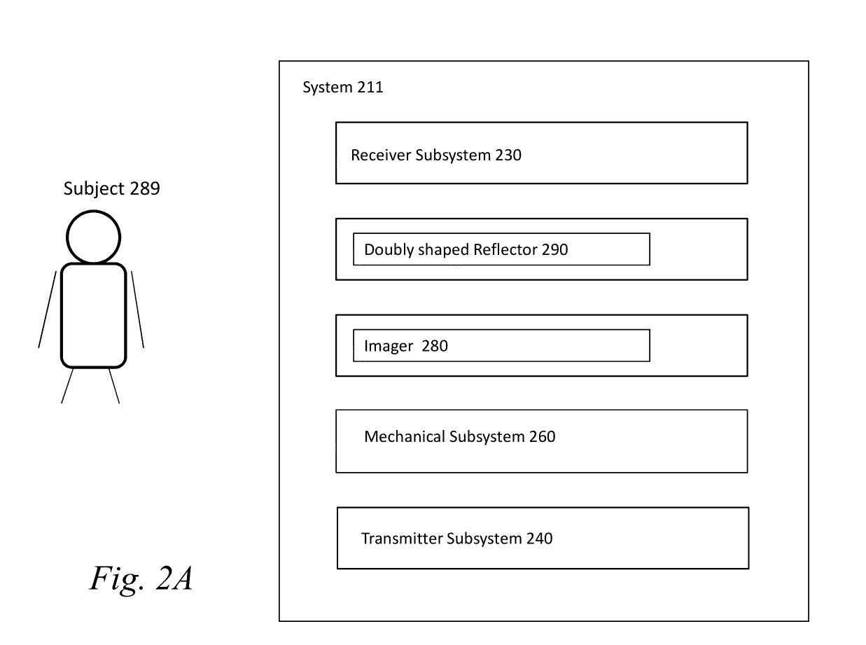

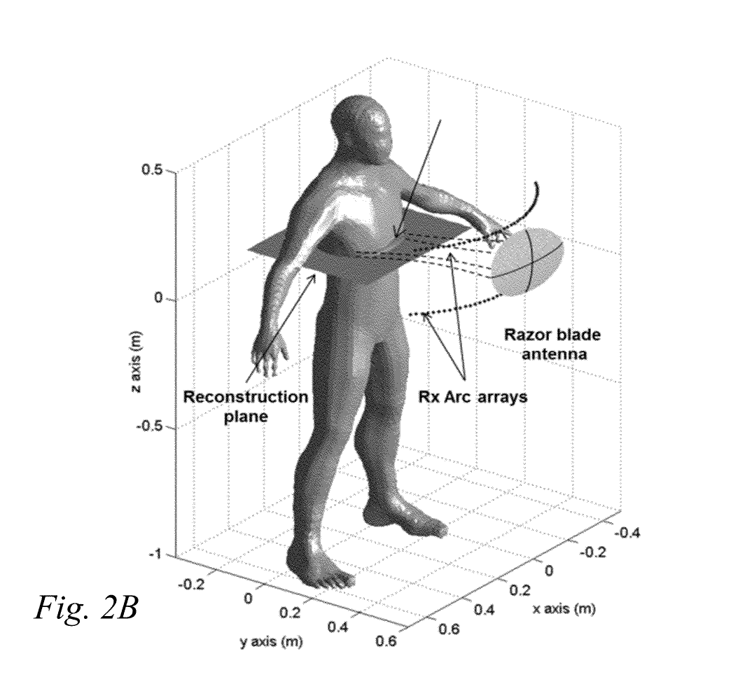

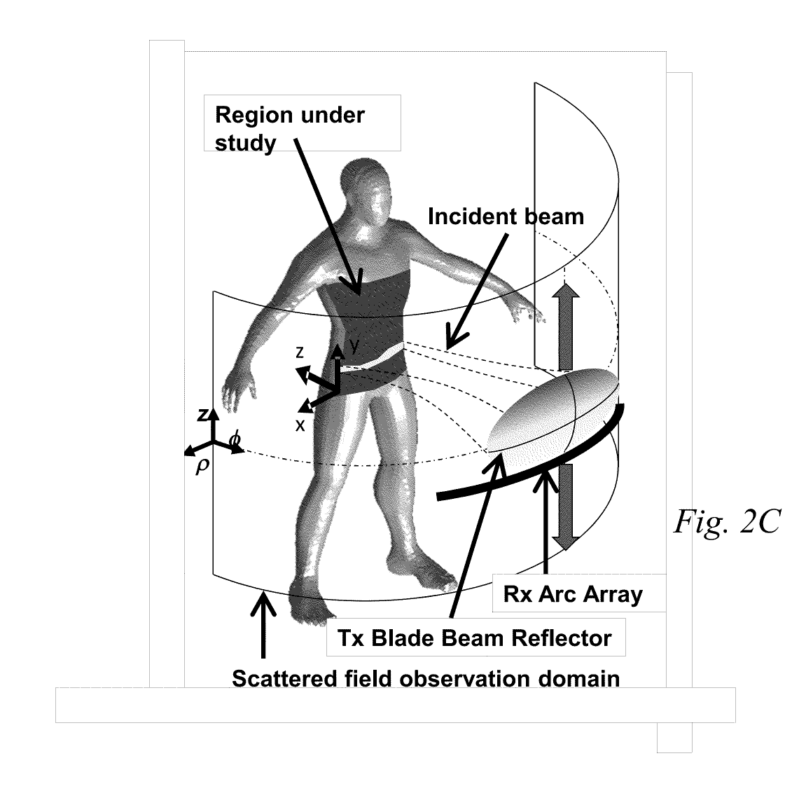

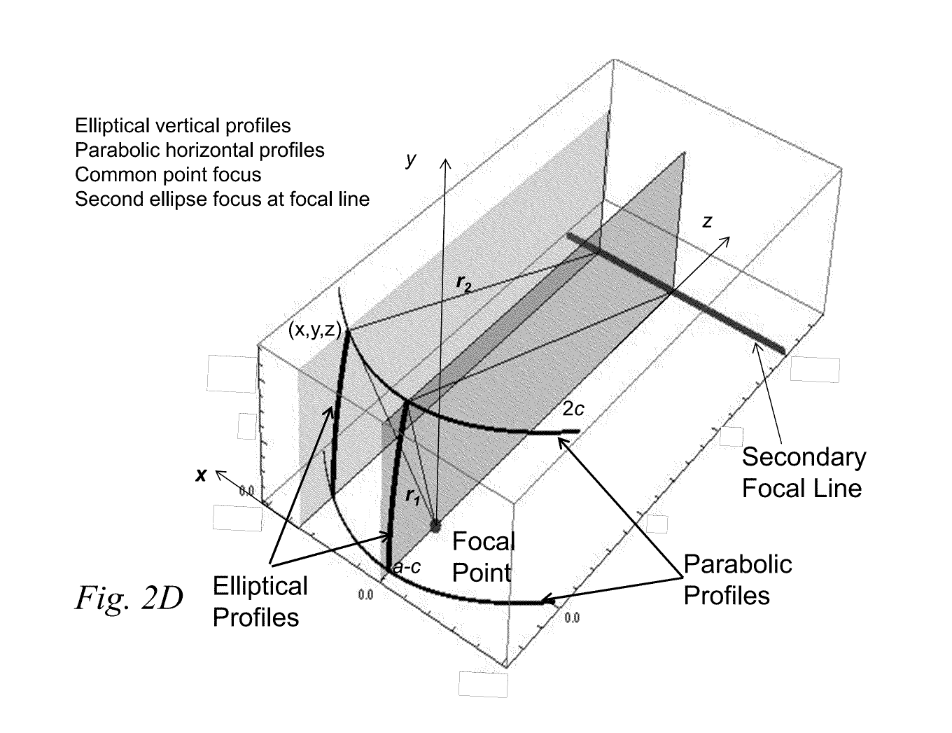

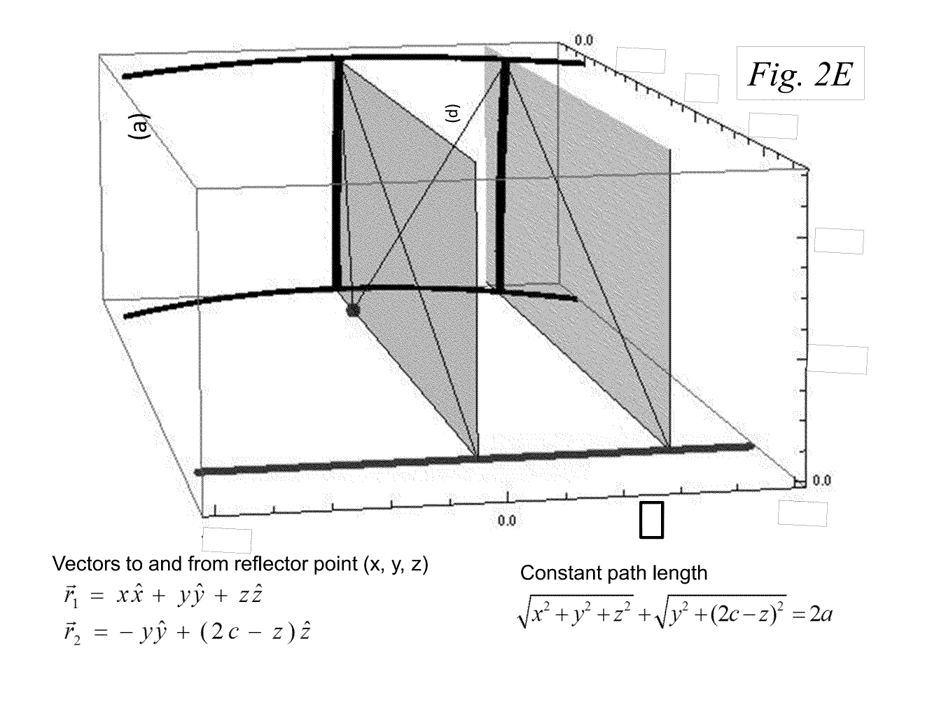

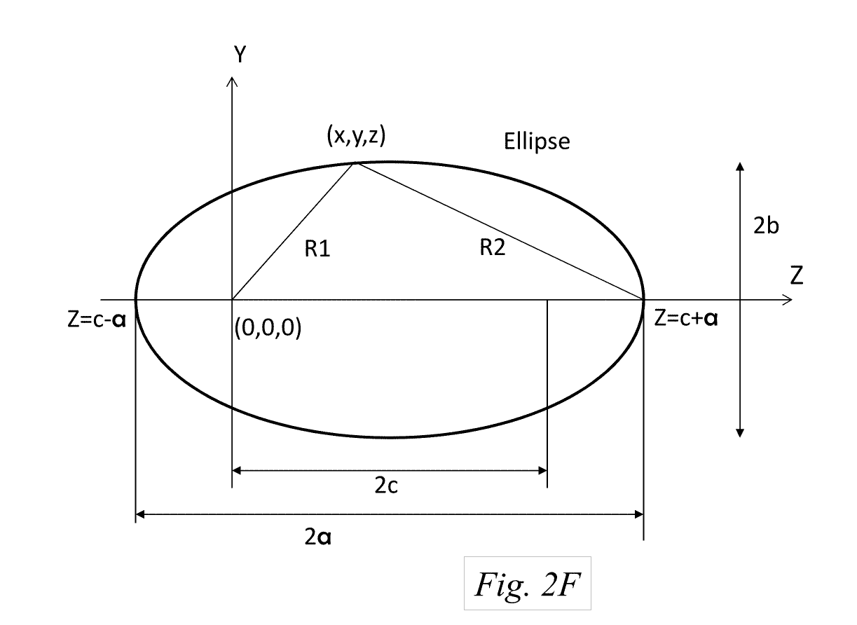

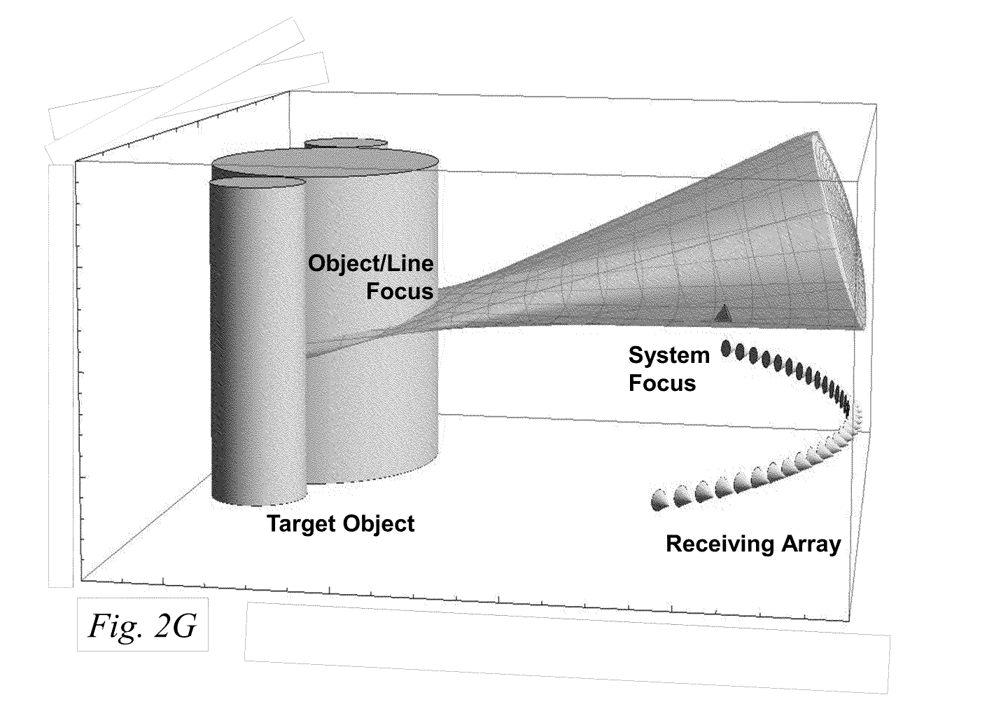

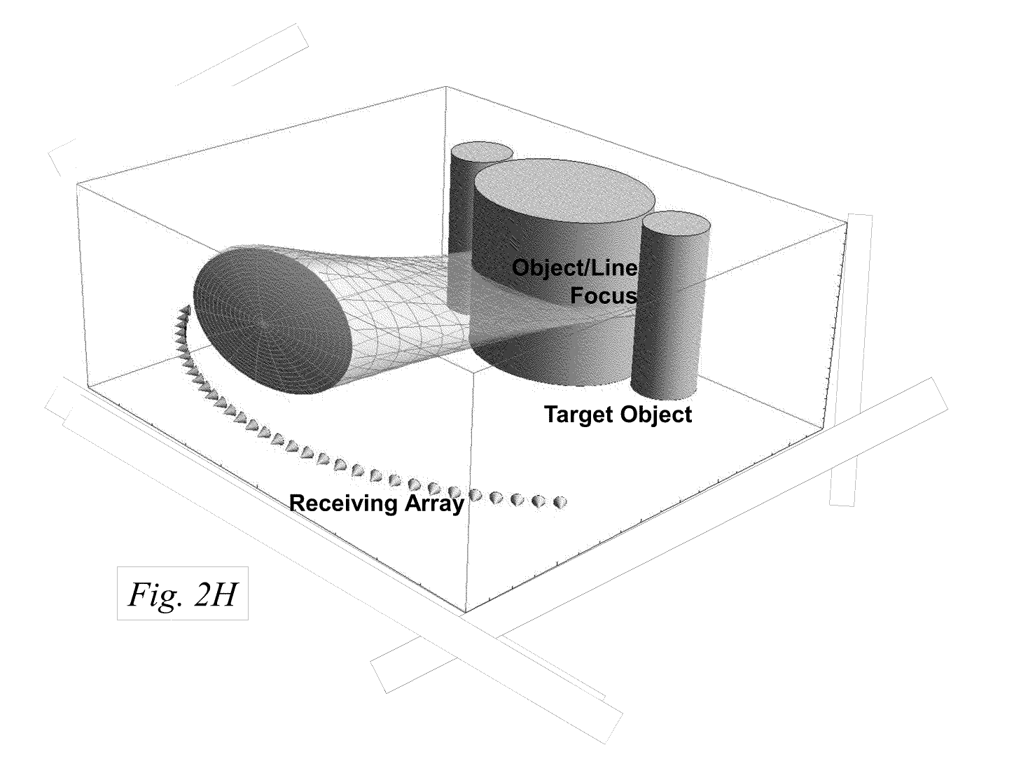

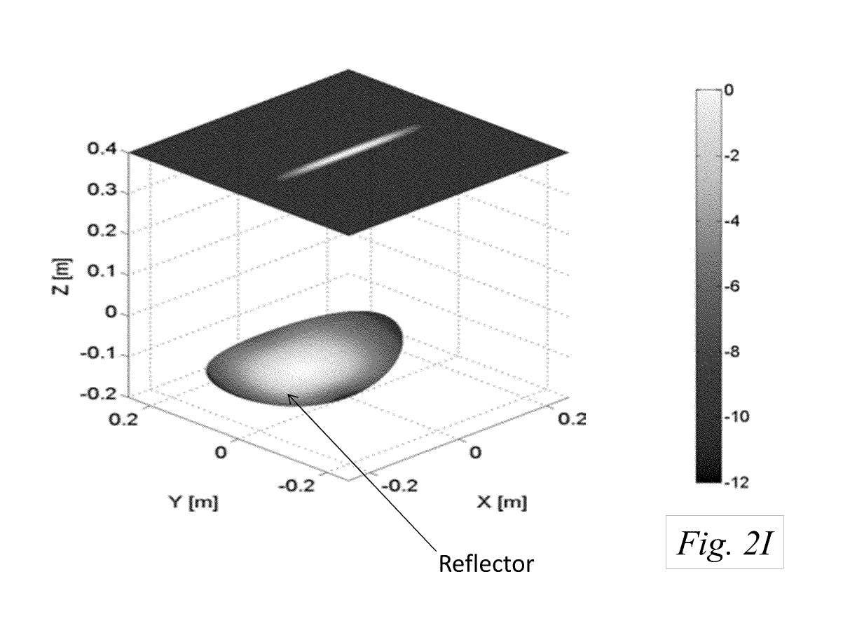

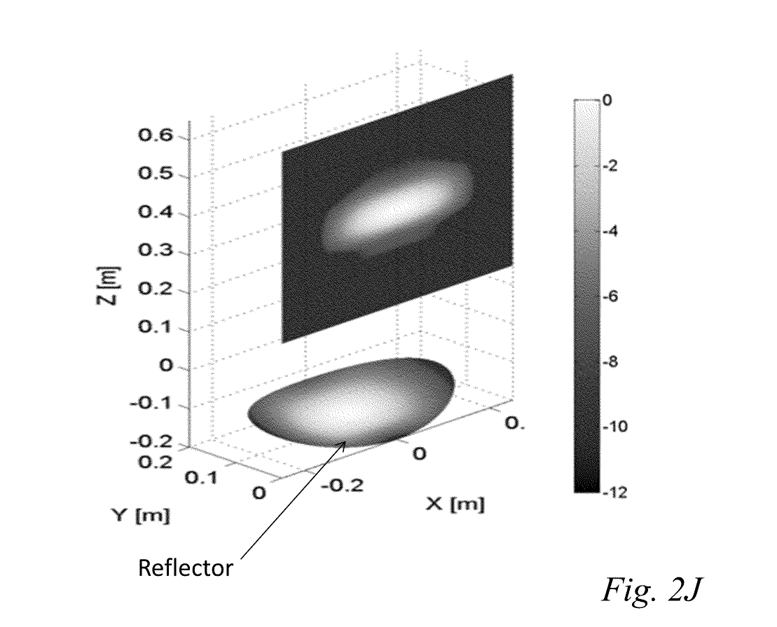

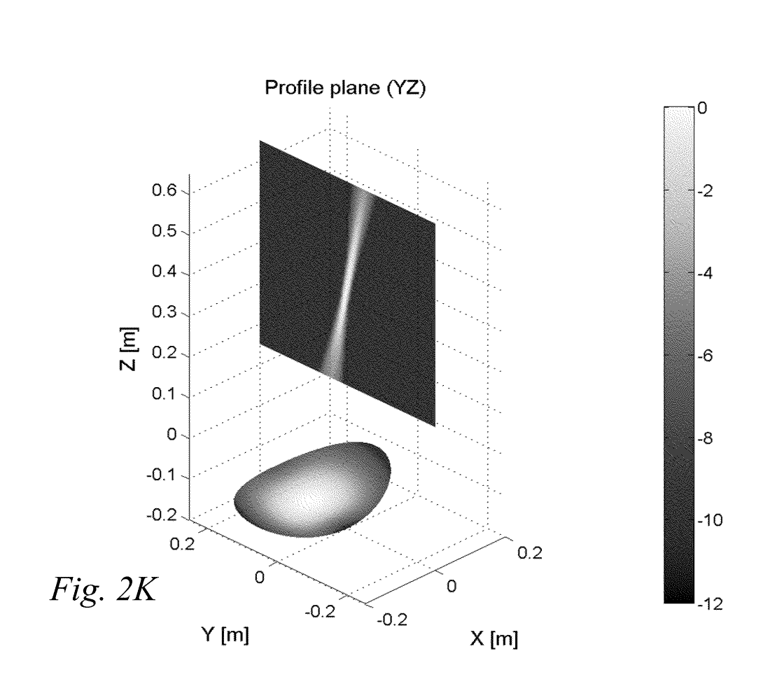

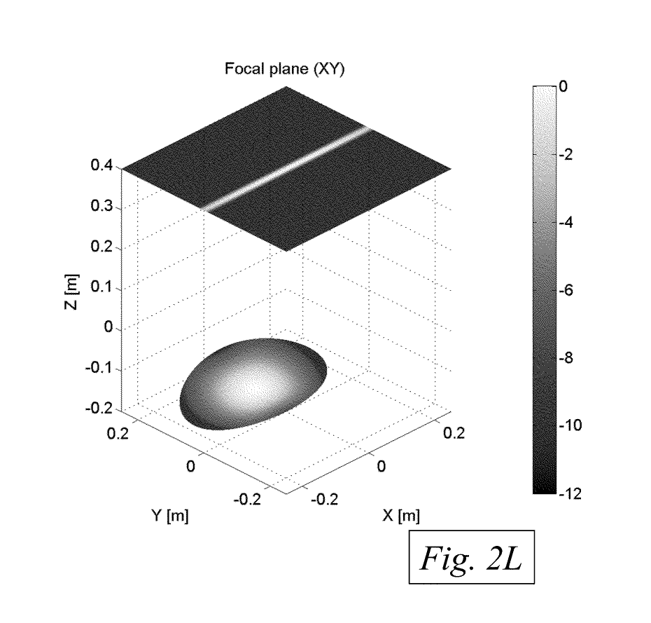

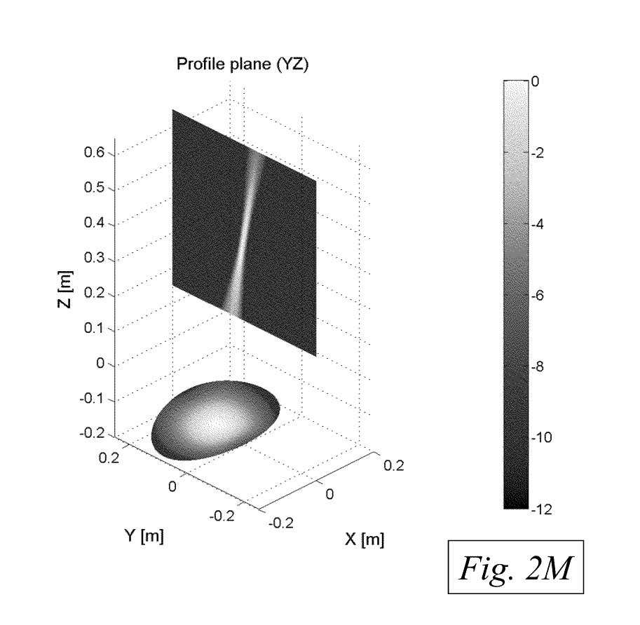

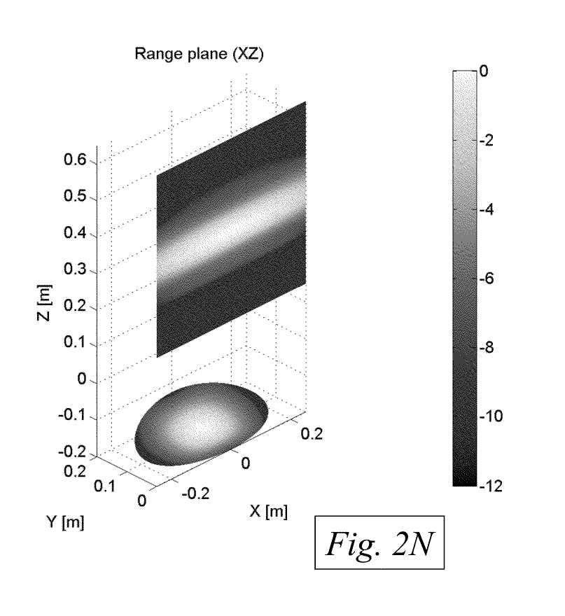

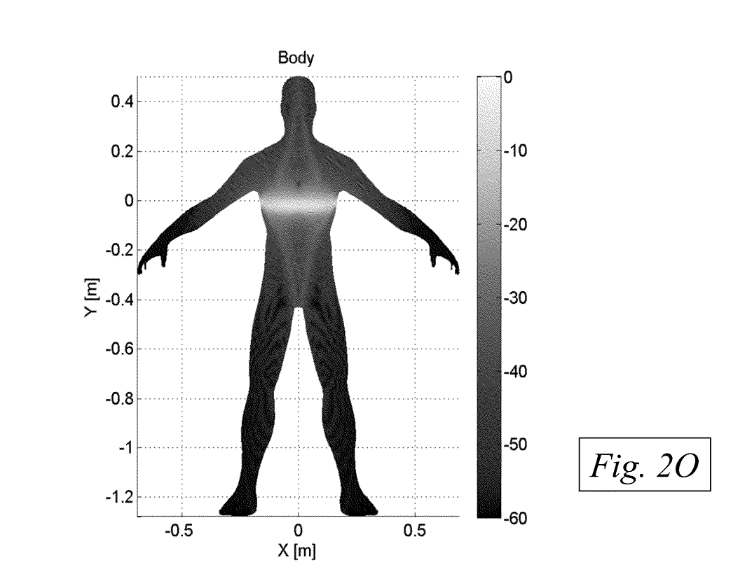

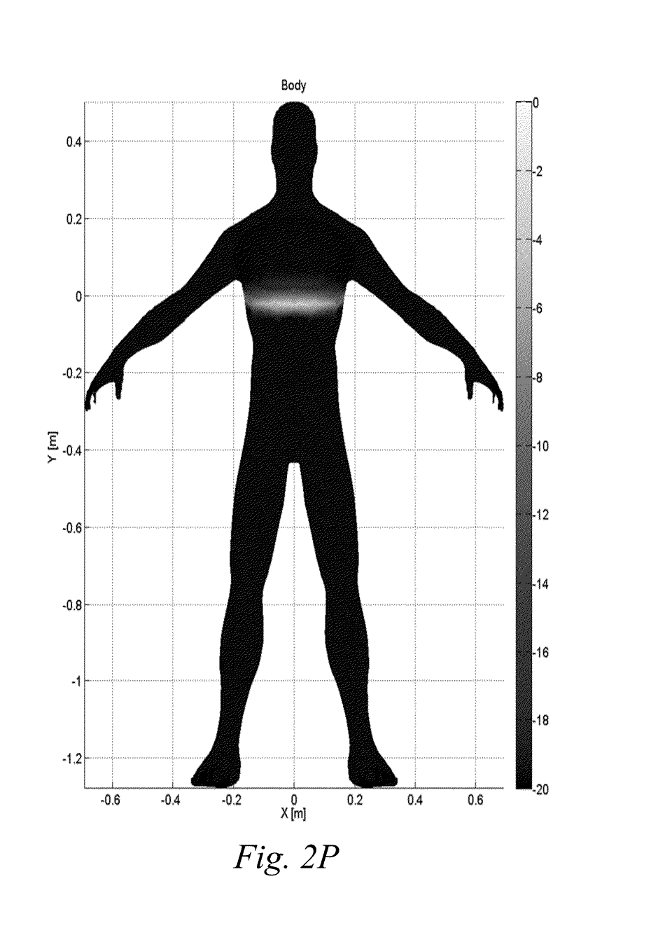

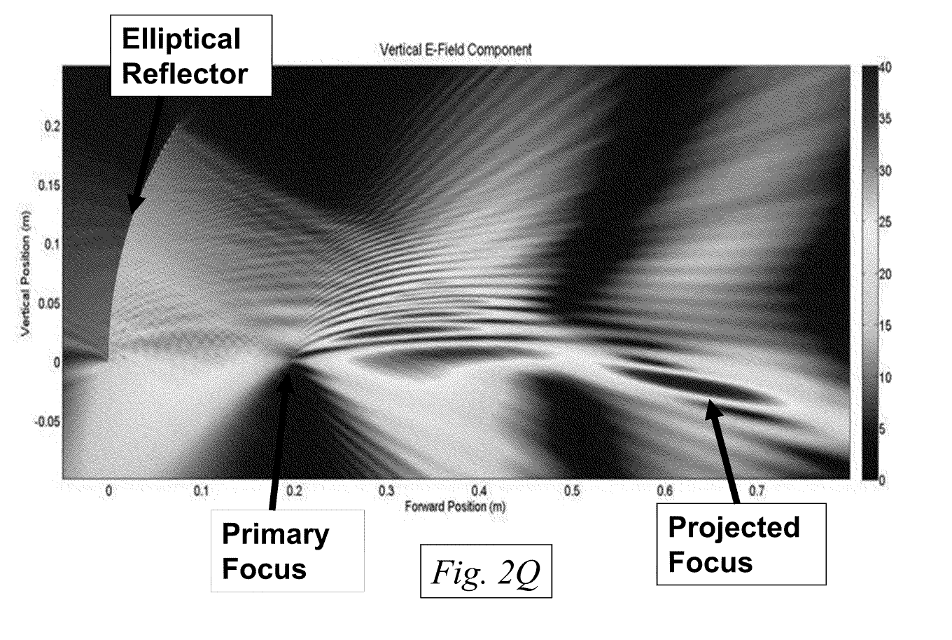

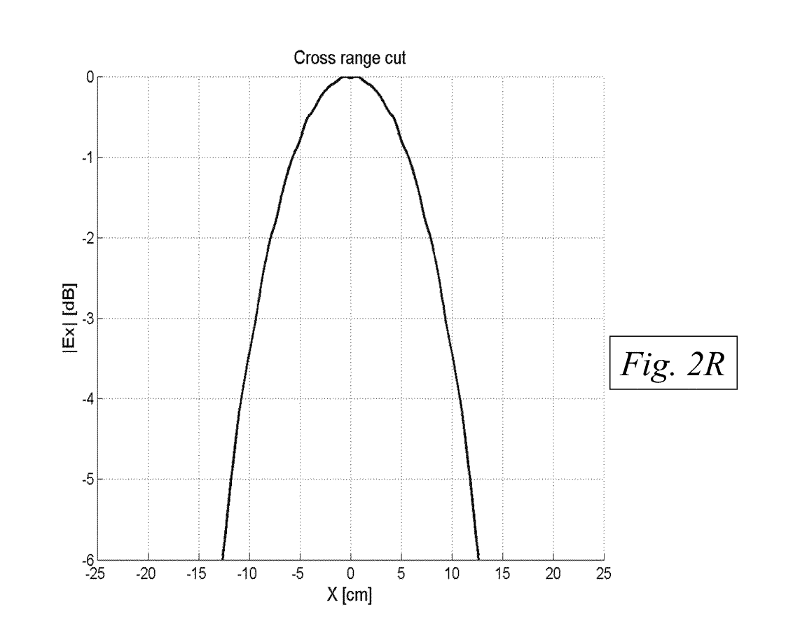

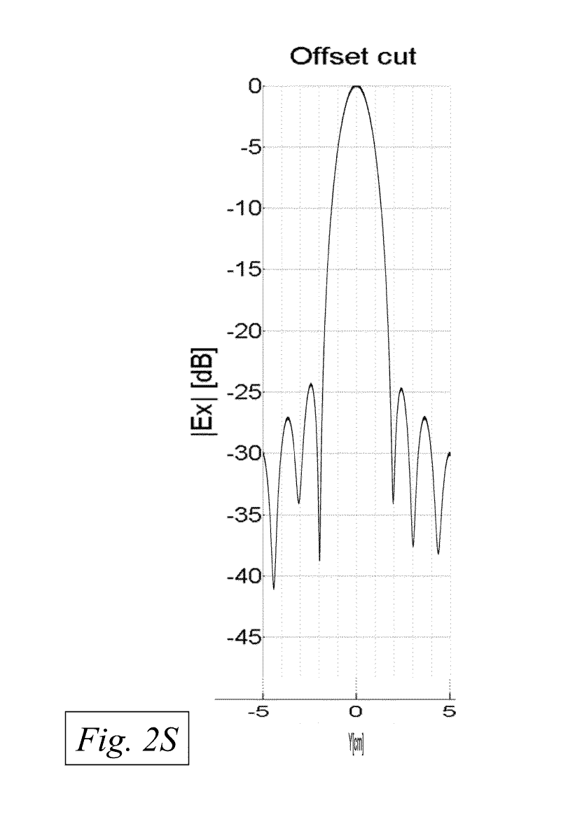

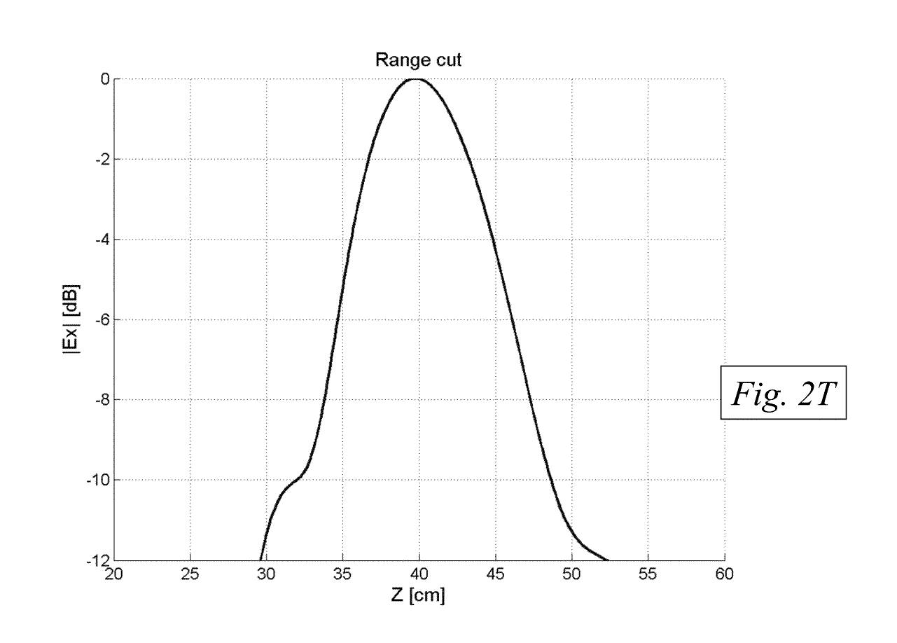

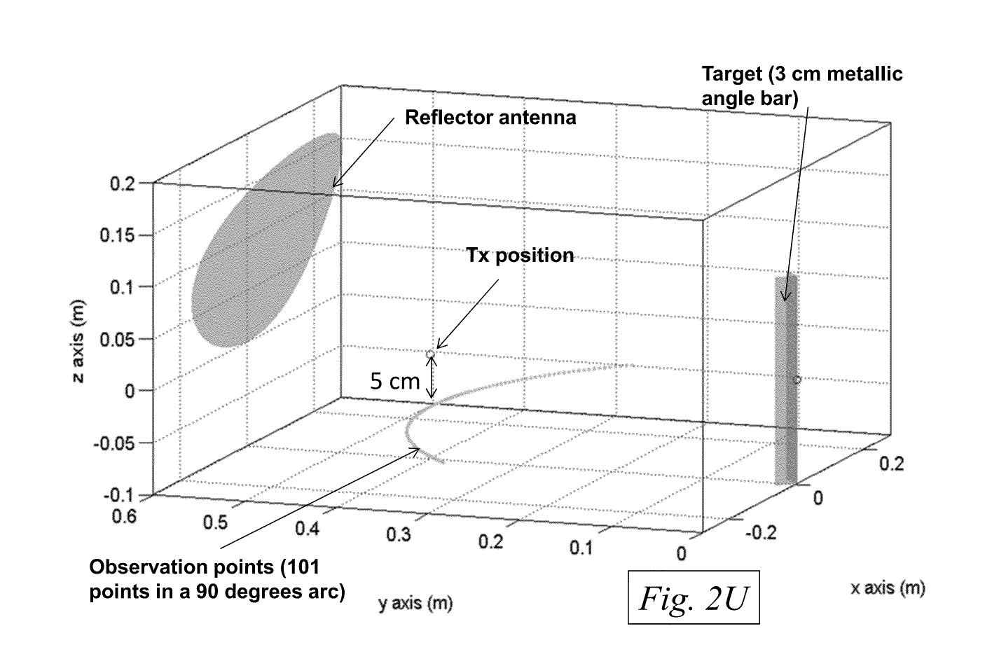

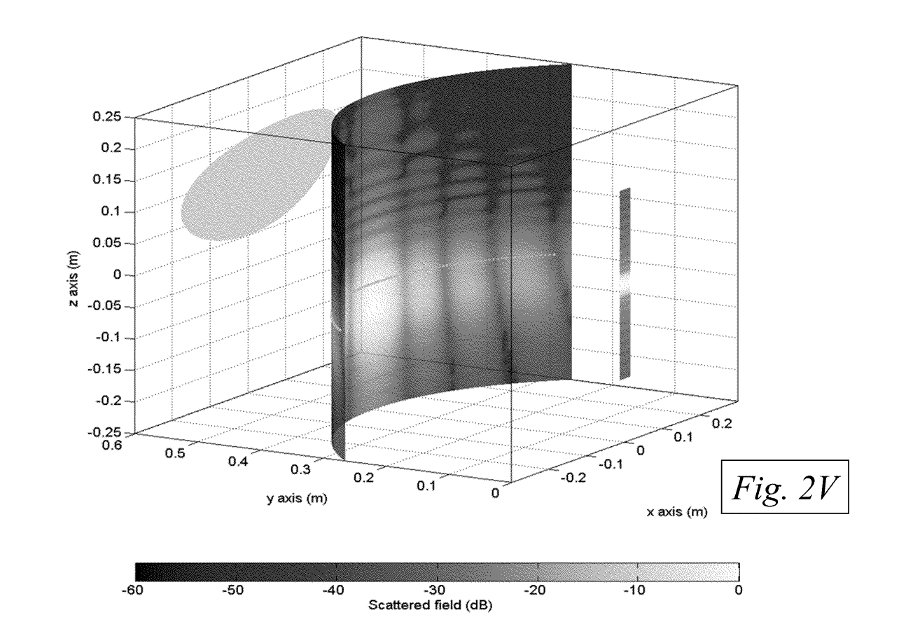

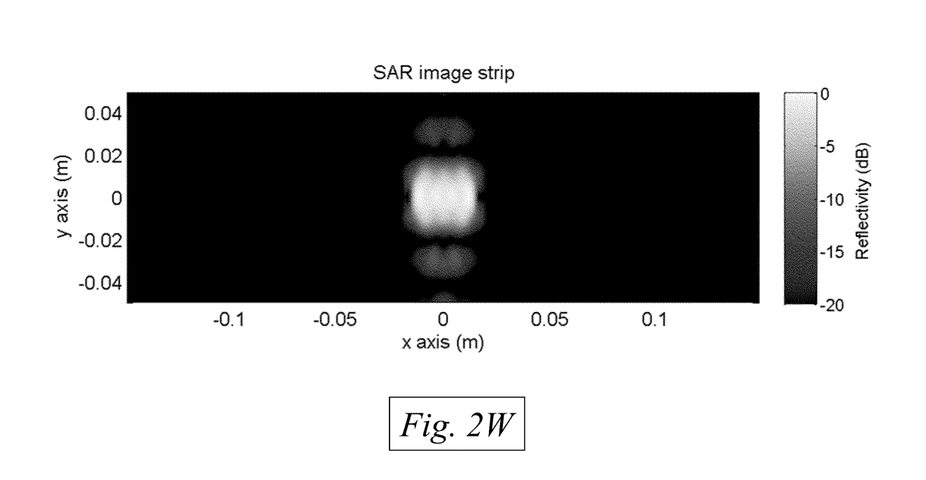

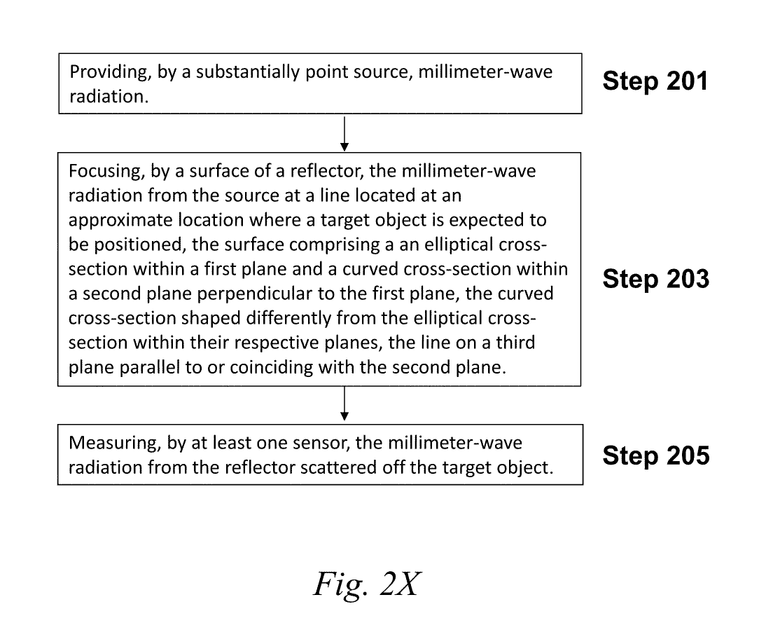

Referring to FIG. 2A, one embodiment of a system for focusing millimeter-wave radiation to a line for scanning a target object is depicted. In brief overview, the system 211 may include one or more of a transmitter subsystem 280 comprising a radiation (e.g., millimeter wave) source, a receiver subsystem 230 comprising at least one sensor, and a doubly-shaped reflector transmitting antenna. It should be understood that radiation of a particular type (e.g., millimeter wave) may sometimes be referenced within this disclosure by way of illustration and are not intended to be limiting in any way. The source may include a point source or a substantially point source for providing radiation. The source may comprise a defined aperture or lens for providing or transmitting millimeter-wave radiation. The reflector may include a surface for focusing the millimeter-wave radiation from the source at a line located at an approximate location where a target object is expected to be positioned. The surface may comprise an elliptical cross-section within a first plane and a curved cross-section within a second plane perpendicular to the first plane. The curved cross-section may be shaped differently from the elliptical cross-section within their respective planes. The line may be on a third plane parallel to or coinciding with the second plane. The at least one sensor may measure the millimeter-wave radiation from the reflector scattered off the target object. The doubly-curved surface can combine different types of focusing in the horizontal and vertical planes, and can be applied to near-field microwave/millimeter-wave/sub-millimeter-wave imaging. Each of the subsystems or modules, e.g., described herein, may be controlled by, or incorporate a computing device, for example as described above in connection with FIGS. 1A-1C.

By way of example, for the security application of a portal-based concealed object detection on a subject, embodiments of the present system may provide selective illumination of horizontal slices of a subject using millimeter-wave radar. Since variation along a subject's height may be considerably less than with a circumference around a human body for example, mutual interaction of one illuminated slice with adjacent ones may be less, and thus can be neglected for practical purposes. The system may focus on a line rather than on a spot. This can reduce, for example: 1) the amount and/or complexity of hardware compared to a full 2D array, 2) the acquisition speed relative to mechanical scanning, and/or 3) the processing burden relative to full 3D inversion. The reflector can provide a wide physical aperture, with multistatic observation.

Referring again to FIG. 2A, the system may include a reflector. The reflector may sometimes be referred to as a reflector antenna, reflector transmitting antenna, transmitting antenna, blade reflector, blade beam reflector, blade antenna, doubly-shaped reflector, or some other variant. The reflector can generate a line focus for millimeter wave illumination, at a predefined distance (e.g., 0.2 m, 0.5 m, 1 m, 5 m, etc). The reflector may combine spot-focusing in a first plane (e.g., the vertical plane) with ray collimation/divergence/convergence in a second plane (e.g., in the horizontal direction or plane). In some embodiments, the reflector may comprise a blending or combination of one type of curvature (e.g., elliptical curvature) in one plane/direction (e.g., in height) with another type of curvature (e.g., parabolic curvature) in another plane/direction (e.g., in width). The reflector antenna may be inherently broadband or configured to be broadband. The reflector may be designed and/or built to be relatively light weight, and may be mechanically moved or translated with little effort and/or inertial. The reflector may be designed to be easy to characterize and/or build.

FIGS. 2B and 2C show embodiments of a configuration of the reflector producing a blade beam to illuminate a subject. The reflector may comprise a vertically translating/focusing blade beam reflector antenna illuminating a narrow horizontal slice on the target subject's body. The narrow horizontal slice may be configured to extend a certain width in the horizontal plane. The width of the beam may be substantially constant, or may vary with distance from the reflector. The beam width may be configured based on a dimension and/or shape of the reflector.

In various applications, the reflector may be re-oriented about any axis (e.g., from the orientation illustrated in FIGS. 2B and 2C), and the beam re-oriented correspondingly. In certain embodiments, changing an offset section of the reflector may offer angular advantages and reduce feed blockage. For example, if it is desired to have the beam reflected from the object under test point downward more, a section of the reflector farther from the axis of symmetry may be chosen and illuminated.

In some embodiments, unlike a conventional paraboloidal reflector, the present reflector may not include a surface of revolution. The reflector may not be composed of separable terms for vertical and horizontal curvature. In some embodiments, and referring to FIGS. 2D and 2E, the reflector's surface may be determined by solving an equation for constant path length sum of a ray from a focal point or system focus at (0, 0, 0), to a presumed surface (x, y, z), and a reflected ray which perpendicularly intersects the focal line z=2c, y=0. The vectors to and from the reflector point (x, y, z), may be represented by:

\vec{r}₁=x\hat{x}+yŷ+z\hat{z}

\vec{r}₂=−yŷ+(2c−z)\hat{z}

In a generalized ellipse, for example as illustrated in the embodiment of FIG. 2F, the constant path length equation may be expressed as:

R1+R2=2a

\sqrt{x²+y²+z²}+\sqrt{y²+(2c−z)²}=2a (1)

a and c are the ellipse semi-major axis and one-half foci separation. The sum of distances from one ellipse focus reflection to the other is 2a. If F is the focal distance for the parabolic profile in the y=0 plane, the vertex of the reflector is then at (x, y, z)=(0, 0, −F). Using the formula for the semi-minor ellipse axis b=\sqrt{a²−c²}, the solution to (1) is:

$$z = c [ 1 + {( \frac{x}{2 b} )}^{2} ] - a \sqrt{{[ 1 - {( \frac{x}{2 b} )}^{2} ]}^{2} - {( \frac{y}{b} )}^{2}} \qquad ( 2 )$$

In the y=0 plane, the profile simplifies to z=x²/4F−F, since F=a−c. In the x=0 plane (e.g., vertical plane of symmetry), the profile becomes: (z−c)²/a²(y/b)²=1. This may be recognized as the ellipse equation. To ensure that the reflector surface reflects rays correctly, Snell's law \vec{r}₂=\vec{r}₁(2\hat{n}·\vec{r}₁)\hat{n} may be confirmed for every point on the reflector, where the unit normal \hat{n}=∇f(x,y,z)/|∇f(x,y,z)|, and f is the right hand side of (2)−z. In the y=0 plane (e.g., horizontal plane of symmetry), the profile may become the following, which may be recognized as the parabola equation:

$$\begin{matrix}z = c [ 1 + {( x / 2 b )}^{2} ] - a [ 1 - {( x / 2 b )}^{2} ] \\ = ( c - a ) + ( c + a ) {( x / 2 b )}^{2} \\ = {x}^{2} / 4 ( a - c ) - ( a - c )\end{matrix}$$

FIGS. 2G and 2H show schematic views of a reflector and a resulting beam as a collection of rays from the reflector to the target object. As shown, the target object is a constant cross section prism representing a cross section of a torso and arms. The system may include a configuration of receiving elements (e.g., arranged in an arc). The reflector focus may be configured to be a line or curve coinciding with or near the target object. In certain embodiments, an elliptical implementation in elevation may provide a tight “blade focus” which may illuminate a narrow slice of the object for image reconstruction. In some embodiments, a parabolic implementation in the azimuth can provide a wide beam and/or parallel incident rays. The incident rays, which may be directed substantially perpendicular to the illuminated surface of the object, can help minimize variations in rays scattering off the illuminated portion of the object. In another implementation, the incident rays may be focused at a curved line, e.g., comprising a concave arc. The curved line or concave arc may conform more closely to the illuminated (and curved) portion of an object. Such a configuration may provide a wider range of incident rays that are substantially perpendicular to the illuminated surface of the object, and can help minimize variations or distortions in rays scattering off an illuminated portion of the object.

In certain embodiments or implementations, we may generalize the parabolic profile into a hyperbolic one. In one implementation, this may produce azimuthal rays that spread or diverge as if they originated from a virtual focal point on the other side of the reflector. The parabolic profile may comprise a special case of the hyperbolic profile in which the second focal point is at z=−∞. For the hyperbolic case, the focal line can become a circular focal arc, centered at (0, 0, −fᵥ), with radius fᵥ+2c. The constant path length equation for this case may be represented as:

$$\sqrt{{x}^{2} + {y}^{2} + {z}^{2}} + \sqrt{{y}^{2} + {( {f}_{v} + 2 c - ρ )}^{2}} = 2 a$$

$$or$$

$$\sqrt{{ρ}^{2} - 2 ρ {f}_{v} cos ϕ + {f}_{v}^{2} + {y}^{2}} + \sqrt{{ρ}^{2} - 2 ρ ( {f}_{v} + 2 c ) + {( {f}_{v} + 2 c )}^{2} {y}^{2}} = 2 a$$

where ρ is the cylindrical radius from the point z=−fᵥ, and φ is the circumferential angle about the displaced y-axis at (x, z)=(0, −fᵥ), measured from the positive z-axis. This equation can be solved for ρ to give a general formula for this surface with elliptical elevation and hyperbolic azimuth profiles, which may be represented by the formula:

$$ρ = \frac{F ( {f}_{v} - F )}{F - ( \frac{{f}_{v}}{2} ) ( 1 - cos ϕ )} + A [ 1 - \sqrt{1 - {( \frac{y}{B} )}^{2}} ]$$

$$where$$

$$A = a \frac{{b}^{2} - {f}_{v} ( {c}_{v} - c cos ϕ )}{{a}^{2} - {c}_{v}^{2}} , \\ B = \frac{{b}^{2} - {f}_{v} ( {c}_{v} - c cos ϕ )}{\sqrt{{a}^{2} - {c}_{v}^{2}}} , \\ F = a - c , \\ and$$

$${c}_{v} = c + ( \frac{{f}_{v}}{2} ) ( 1 - cos ϕ ) .$$

For the profiles on the planes of symmetry, when φ=0, A=a, B=b, cᵥ=c. So

$$ρ = z + {f}_{v} = ( c - a + {f}_{v} ) + a [ 1 - \sqrt{1 - {( \frac{y}{b} )}^{2}} ] ,$$

which is the standard formula for an ellipse with left focus at (x, z)=(0, 0). When y=0, the hyperbolic parameters aₕ, bₕ, cₕ can be inserted as:

$$F = {c}_{h} - {a}_{h} , \\ {f}_{v} = 2 {c}_{h}$$

$$and$$

$${b}_{h}^{2} = {c}_{h}^{2} - {a}_{h}^{2} , \\ and$$

$$so ρ = \frac{{b}_{h}^{2}}{{c}_{h} cos ϕ - {a}_{h}} ,$$

which is the standard formula for a hyperbola. The hyperbolic form has the effect of spreading out the blade beam to illuminate a slice of the subject or object that may be wider than the reflector. This form may diverge rays from the source to provide a wider beam of illumination.

In some embodiments, the hyperbolic formulation may be configured to produce azimuthal rays that converge as the rays approaches the target object. The azimuthal rays may, for example, be configured to converge at a distance beyond a target surface of the subject. In such cases, the reflector may produce a blade beam that focuses on a curved line, for example, comprising a concave arc. The line of focus may conform more closely to a surface of a target object (e.g., a curved torso of a human). The converging rays may result in reduced variations or distortions from rays scattering off the target surface. The converging rays may result in reduced scattering interaction between adjacent illuminated portions/slices of the target object, when reconstructing a surface of the object from the slices. The existing hyperbolic formulation may be implemented with the particular or extended specification of making the hyperbola focal length fᵥ have an opposite sign. That is, fᵥ=−fᵥ (e.g., substituting or replacing fᵥ with −fᵥ), can generate an elliptical-elliptical configuration in the reflector surface. The reflector surface may comprise different elliptical curvatures in its vertical and horizontal (or perpendicular) profiles. Accordingly, in various embodiments, the reflector may be oriented about any axis, so that its characteristic beam-forming and/or focusing profiles may be rotated or oriented accordingly to suit particular applications. In addition, the reflector can be sized accordingly to provide appropriate illumination coverage, for example depending on the size of a target object.

Referring now to FIGS. 2I, 2J and 2K, embodiments of radiation characteristics provided by a system for focusing millimeter-wave radiation to a line for scanning a target object, are depicted. Each of these figures may illustrate particular aspects of a 3D radiation characteristic of one embodiment of a blade beam reflector. For example, FIGS. 2I and 2J illustrate field intensity of radiation in the focal region for the transverse and longitudinal planes for the reflector. By way of a non-limiting example, the reflector may be configured with a=40 cm, c=20 cm, width 40 cm and height 20 cm. The field is observed to be narrow in the y-direction (e.g., in the focal or XY plane). In addition, this narrow focal region can be configured to persist across a range (e.g., 15 cm of range), e.g., in the range plane or XZ plane as shown in FIG. 2J. This may also be observed in the profile of YZ plane as shown in FIG. 2K. Such an beam profile may be an advantage for illuminating objects with significant depth (or range) variation, such as the human torso. FIGS. 2L, 2M and 2N show other embodiments of radiation characteristics provided by a system using a variant shape of the reflector.

Referring now to FIGS. 2O and 2P, embodiments of radiation characteristics provided by a system for focusing millimeter-wave radiation to a line for scanning a target object, are depicted. These Figures are illustrative of illumination profiles provided by one embodiment of a blade beam reflector on a body of an subject. Referring to FIG. 2Q, another embodiment of radiation characteristics provided by a system for focusing millimeter-wave radiation to a line for scanning a target object, is depicted. Relative to an elliptical reflector, both a primary focus and a secondary (or projected) focus are shown. In some embodiments, an illumination source is provided at the primary focus, and projects radiation towards the reflector. The reflector can focus the rays at the secondary or projected focus, e.g., where the focus line resides. FIGS. 2R, 2S and 2T show three cuts through a secondary focal region to illustrate radiation characteristics provided by one embodiment of a system for focusing millimeter-wave radiation to a line for scanning a target object.

FIG. 2U shows another embodiment of a system for focusing millimeter-wave radiation to a line for scanning a target object. By way of a non-limiting illustration, the target object may comprise a vertical flat metallic strip. FIG. 2V shows one embodiment of an expected scattered field arising from the system focusing millimeter-wave radiation at the target object. FIG. 2W shows one embodiment of an image constructed or derived from scattered field arising from the system focusing millimeter-wave radiation at the target object. The image may be constructed from measurements ranging from 56 to 63 GHz, at 11 steps, using a MECA forward model or method (e.g., no mutual coupling), and SAR inversion, for example.

The present systems and methods can offer advantages over former or existing systems. For example, prolate spheroidal reflectors comprised from rotating an ellipse about an axis of revolution focus waves originating from one focal point to the other. However, if this type of reflector is used to illuminate a surface of interest, it may need to be mechanically scanned across all vertical and horizontal positions. This may require much more motion and scanning time than the present reflector. In some systems, waves may be focused to a point for imaging applications. However, the point may need to be raster-scanned across both width and height dimensions to view the entire object of interest. This can require much more complicated mechanical motion and much more time to scan.

Referring now to FIG. 2X, one embodiment of a method for focusing millimeter-wave radiation to a line for scanning a target object, is depicted. A source may provide millimeter-wave radiation, and may include a substantially point source (201). A reflector may include a surface with an elliptical cross-section within a first plane and a curved cross-section within a second plane perpendicular to the first plane (203). The curved cross-section may be shaped differently from the elliptical cross-section within their respective planes. The surface may focus the millimeter-wave radiation from the source at a line on a third plane parallel to or coinciding with the second plane. The line may be located at an approximate location where a target object is expected to be positioned. At least one sensor may measure the millimeter-wave radiation from the reflector scattered off the target object (205).

Referring now to (201), and in some embodiments, a source may provide millimeter-wave or another type of radiation. The source may comprise a substantially point source for millimeter-wave radiation. The source may provide any type of radiation or radar suitable for probing or investigating a target object or subject. For example, the source may provide sub-millimeter waves, millimeter-waves, microwaves, terahertz waves as part of a radar system. The source may provide or direct radiation towards a reflector. The source may be located at a predetermined distance or location from the reflector. The source may be located at a predetermined distance or location between the reflector and the target object. The source may be located at a focal point (e.g., a first or primary focal point) of an elliptical profile of the reflector. The source may provide radiation from a focal point of an elliptical profile of the reflector.

The source may be located and/or oriented in a predefined configuration with respect to the reflector. In some embodiments, the source may be translated, moved and/or rotated at a same location and/or orientation relative to the reflector. The source may be configured or designed to have a small profile so as not to significantly obstruct radiation from the reflector (e.g., to the target object) and/or scattered field from the target object (e.g., to a receiver antenna or sensor).

Referring now to (203), and in some embodiments, a reflector may include a surface with an elliptical cross-section or profile within a first plane and a curved cross-section or profile within a second plane perpendicular to the first plane. The reflector may include a surface with a first elliptical cross-section or profile within the first plane. In some embodiments, the first and second planes may be substantially perpendicular to each other. In certain embodiments, the first and second planes may not be perpendicular to each other. The curved cross-section may be shaped differently from the elliptical cross-section within their respective planes. For example, the curved cross-section may comprise another elliptical cross-section (e.g., a second elliptical cross-section), a hyperbolic cross-section or a parabolic cross-section, shaped differently from the first elliptical cross-section. The reflector may provide beam shaping function for rays from the source. The reflector may provide ray focusing function for rays from the source. The reflector may provide a blade beam for scanning or probing a portion or slice of a surface of the target object. The reflector may be shaped to operate or couple with a source that is substantially pointed or small. The reflector antenna may comprise a portion of a synthetic aperture radar system. In some embodiments, the surface may focus the radiation at the line, the line comprising a curved or straight line on the third plane.

In some embodiments, the curved cross-section may comprise another elliptical cross-section (e.g., a second elliptical cross-section) different from the elliptical cross-section in the other plane. For example, the major axis and/or minor axis of each elliptical profile may be configured differently. The reflector surface may comprise different elliptical curvatures in its vertical and horizontal (or perpendicular) profiles. The surface may focus the millimeter-wave radiation from the source at a line on a third plane parallel to or coinciding with the second plane. The line may be located at an approximate location where a target object is expected to be positioned. The line may be located at a second focal point of the elliptical profile within the first plane. The line may be located away from a second focal point of the elliptical profile within the second plane. The line may comprise a curved line, for example, a concave arc of a circle, or a portion of a parabola, hyperbola, ellipse or any other shape or structure. The line of focus may conform more closely to a surface of a target object (e.g., a curved torso of a human). The surface may provide rays that are converging towards the target object. The converging rays may result in reduced variations or distortions in scatterings from the target surface. The converging rays may result in reduced scattering interaction between adjacent illuminated portions/slices of the target object, when reconstructing a surface of the object from the slices. In effect, the surface may focus the rays to form a concave blade beam.

In some embodiments, the surface focuses the millimeter-wave radiation at the line, the surface comprising a parabolic cross-section along the second plane. The surface may focus the millimeter-wave radiation at the line, the line comprising a straight line on the third plane. The surface may be parabolic in the azimuth or horizontal plane, and may provide a wide radiation beam in this plane. The surface may focus the millimeter-wave radiation to comprise collimated rays within the second plane. The surface may provide collimated or parallel incident rays in the second or azimuth plane. In effect, the surface may focus the rays to form a straight or substantially straight blade beam. The surface may provide illumination in the second or azimuth plane, of a width the same or substantially the same as the surface's width.

In some embodiments, the surface focuses the millimeter-wave radiation at the line, the surface comprising a hyperbolic cross-section along the second plane. The surface may focus the millimeter-wave radiation at the line, the line comprising a circular arc on the third plane. The surface may be hyperbolic in the azimuth or horizontal plane, and may provide a wide radiation beam in this plane. The surface may provide diverging incident rays in the second or azimuth plane. In effect, the surface may focus the rays into a curved or substantially convex blade beam. The surface may provide illumination in the second or azimuth plane, of a width wider than the surface's width.

In certain embodiments, the surface focuses the millimeter-wave radiation at the line, the surface providing constant path length sum for millimeter-wave radiation from the source to any point on the reflector, and from that point to the line of focus in a perpendicular manner, for example, as described above in connection with at least FIGS. 2D-2F. The surface may focus the millimeter-wave radiation at the line to provide an extended scanning range on the third plane. The surface may focus the millimeter-wave radiation to a narrow focal region, configured to persist across a range (e.g., 15 cm of range). This narrow focal region may persist, e.g., in the range plane or XZ plane, for example as discussed above in connection with FIG. 2J. For example, the extended scanning range may comprise a radiation pattern or beam thickness of a predefined value (e.g., 5 mm) or less, at and around the focal region. The predefined value may be selected to reduce or optimize computational effort in processing the scattered field from an illuminated slice of the target object, to image the target object. The extended scanning range may be configured to comprise distances (proximate to the location of the line) at which the target object may be scanned with the focused millimeter-wave radiation.

Referring now to (205), and in some embodiments, at least one sensor may measure the millimeter-wave radiation from the reflector scattered off the target object. The at least one sensor or receiving antenna may be configured as an arc receiver subsystem. For example and in some embodiments, a plurality of sensors may be configured or spaced along a portion of a circle (e.g., a quarter circle). The plurality of sensors may reside at sparse element positions. A mechanical subsystem may move at least one of: the source, the reflector and the at least one sensor, relative to the target object. The mechanical subsystem may move and/or rotate the target object relative to at least one of: the source, the reflector and the at least one sensor. The at least one sensor may be configured to move with the source or transmitter and/or the reflector, relative to the target object. The mechanical subsystem may move the detector and reflector up, down or around the target object. For example, the mechanical subsystem may move at least one of: the source, the reflector and the at least one sensor, in a direction substantially perpendicular to the third plane.

The at least one sensor may comprise part of a multistatic radar system. The at least one sensor may measure the millimeter-wave radiation from the reflector scattered off the target object. The measurements may be performed at predetermined points along the direction of movement. For example, the measurements may be performed at fixed intervals points along the direction of movement, corresponding to adjacent illuminated slices of the target object.

In some embodiments, the system may provide at least one other reflector surface to focus millimeter-wave radiation from a different direction relative to the target object. For example, the system may comprise two reflector surface to focus millimeter-wave radiation from two sides (e.g., a front and a back side) of the target object. The system may comprise three or more reflector surfaces, e.g., to provide 360 coverage of a target object. The one of more reflector surfaces may operate and/or move independently or in synchronization, to scan portions of the target object.

In various aspects, the present systems and methods uses a doubly-shaped reflector to generate a narrow illuminating slice within a predetermined range for millimeter-wave imaging. The beam produced by this Blade Beam reflector may be focused to a narrow region in the vertical plane, and may be collimated, converging or diverging in the horizontal plane. This beam configuration can allow for interrogation and reconstruction of a narrow portion of the target object. The reflector and receiving antenna array may be translated vertically relative to the target object. Narrow reconstructions obtained from measurements by the receiver array may be stacked to form a full or partial surface body reconstruction.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A system for focusing microwave, millimeter wave or sub-millimeter wave radiation to a line for scanning a target object, the system comprising:
a source that provides microwave, millimeter wave or sub-millimeter wave radiation, the source comprising a substantially point source;
a reflector comprising a surface with an elliptical cross-section within a first plane and a curved cross-section within a second plane perpendicular to the first plane, the curved cross-section shaped differently from the elliptical cross-section within their respective planes, the surface focusing the radiation from the source at a line on a third plane parallel to or coinciding with the second plane, the line located at an approximate location where a target object is expected to be positioned; and
at least one sensor that measures the radiation from the reflector scattered off the target object.

2. The system of claim 1, wherein the surface comprises a parabolic cross-section along the second plane, the surface focusing the radiation at the line, the line comprising a straight line on the third plane.

3. The system of claim 1, wherein the surface comprises a hyperbolic cross-section along the second plane, the surface focusing the radiation at the line, the line comprising a circular arc on the third plane.

4. The system of claim 1, wherein the surface focuses the radiation at the line, the line comprising a curved line on the third plane.

5. The system of claim 1, wherein the surface provides constant path length sum for radiation from the source to any point on the reflector, and from that point to the line of focus in a perpendicular manner.

6. The system of claim 1, wherein at least one of: the source, the reflector and the at least one sensor, is moved in a direction substantially perpendicular to the third plane, relative to the target object.

7. The system of claim 6, wherein the at least one sensor measures radiation scattered from the target object at predetermined points along the direction of movement.

8. The system of claim 1, further comprising at least one other reflector surface to focus radiation from a different direction relative to the target object.

9. The system of claim 1, wherein the surface focuses the radiation at the line to provide an extended scanning range on the third plane, the extended scanning range comprising distances proximate to the location of the line at which the target object may be scanned with the focused radiation.

10. The system of claim 1, wherein the surface focuses the radiation to comprise collimated rays within the second plane.

11. A method for focusing microwave, millimeter wave or sub-millimeter wave radiation to a line for scanning a target object, comprising:
(a) providing, by a substantially point source, microwave, millimeter wave or sub-millimeter wave radiation;
(b) focusing, by a surface of a reflector, the radiation from the source at a line located at an approximate location where a target object is expected to be positioned, the surface comprising a an elliptical cross-section within a first plane and a curved cross-section within a second plane perpendicular to the first plane, the curved cross-section shaped differently from the elliptical cross-section within their respective planes, the line on a third plane parallel to or coinciding with the second plane; and
(c) measuring, by at least one sensor, the radiation from the reflector scattered off the target object.

12. The method of claim 11, wherein (b) comprises focusing, by the surface, the radiation at the line, the surface comprising a parabolic cross-section along the second plane, the surface focusing the radiation at the line, the line comprising a straight line on the third plane.

13. The method of claim 11, wherein (b) comprises focusing, by the surface, the radiation at the line, the surface comprising a hyperbolic cross-section along the second plane, the surface focusing the radiation at the line, the line comprising a circular arc on the third plane.

14. The method of claim 11, wherein (b) comprises focusing, by the surface, the radiation at the line, the line comprising a curved line on the third plane.

15. The method of claim 11, wherein (b) comprises focusing, by the surface, the radiation at the line, the surface providing constant path length sum for radiation from the source to any point on the reflector, and from that point to the line of focus in a perpendicular manner.

16. The method of claim 11, comprising moving at least one of: the source, the reflector and the at least one sensor, in a direction substantially perpendicular to the third plane, relative to the target object.

17. The method of claim 16, wherein (c) comprises measuring, by the at least one sensor, the radiation from the reflector scattered off the target object, the measurement performed at predetermined points along the direction of movement.

18. The method of claim 11, further comprising providing at least one other reflector surface to focus radiation from a different direction relative to the target object.

19. The method of claim 11, wherein (b) comprises focusing the radiation at the line to provide an extended scanning range on the third plane, the extended scanning range comprising distances proximate to the location of the line at which the target object may be scanned with the focused radiation.

20. The method of claim 11, wherein (b) comprises focusing the radiation to comprise collimated rays within the second plane.
